(19) United States
(12) Patent Application Publication
(10) Pub. No.: US 2018/0130146 A1
(43) Pub. Date: May 10, 2018

(54) Weather Augmented Risk Determination System

(71) Applicant: The Regents of the University of California, Oakland, CA (US)

(72) Inventors: Amir AghaKouchak, Irvine, CA (US); Mohsen Niknejad, Irvine, CA (US); Omid Mazdiyasni, Irvine, CA (US); Farshad Momtaz, Laguna Hills, CA (US)

(21) Appl. No.: 15/806,143

(22) Filed: Nov. 7, 2017

Related U.S. Application Data
(60) Provisional application No. 62/418,363, filed on Nov. 7, 2016.

(51) Int. Cl. G06Q 50/08; G06Q 10/06; G06Q 30/06

(52) U.S. Cl. CPC G06Q 50/08; G06Q 10/06313; G06Q 30/0611; G06Q 10/0635

(57) ABSTRACT

The invention provides an automated tool for predicting the effects of weather on labor productivity. Using the cumulative distribution function or a like probabilistic analysis, the impact of weather on work stoppages and labor productivity is determined using historical weather data. The tool can predict delays due to weather for a specific project site, and can be adapted to projects such as those in the fields of construction, agriculture, and transportation. The output of the tool is a probabilistic analysis that enables planners to determine the likelihood of different time-to-completion scenarios, based on historical weather.

### CROSS-REFERENCE TO RELATED APPLICATIONS

This application claims the benefit of priority to U.S. Provisional Application Ser. No. 62/418,363 entitled “Weather Augmented Risk Determination System,” filed Nov. 7, 2016, the contents which are hereby incorporated by reference.

### STATEMENT REGARDING FEDERALLY SPONSORED RESEARCH OR DEVELOPMENT

Not Applicable

### BACKGROUND OF THE INVENTION

Weather has an enormous impact on various economic activities. For example, it has been estimated that over one third of the United States GDP is weather-sensitive, involving some degree of weather risk. Outdoor work can be hindered by precipitation, high winds, extreme temperatures, high relative humidity and other weather conditions. Additionally, labor productivity is generally known to be affected by weather conditions. The anticipated timing and costs of a project will vary depending upon the degree of weather risk inherent in the particular endeavor. Furthermore, given the enormous range of weather conditions across locales and across the time of year, the anticipated timing and costs of a particular project will vary substantially based on the location and timing of the project.

For example, the construction industry is a large sector of the economy, and is also greatly influenced by weather-related risks including work stoppage and low labor productivity. Identification and quantification of these risks, and providing mitigation of their effects are always the concerns of construction project managers. Weather impacts are reported to be one of the biggest factors that cause cost overruns and delays in construction projects. There are different ways weather conditions can cause delays in construction projects. Severe weather conditions such as very low temperatures, very high temperatures, wind, rain, and snow can cause complete work stoppages. For example, work stoppages may occur when weather completely inhibits the ability of workers to operate, prevents the use of various materials (e.g. concrete, paint), prevents the use of certain equipment (e.g. cranes in high wind), or forces a work stoppage in order to comply with safety regulations. Labor productivity is another weather-dependent factor which has a strong influence on the scheduling, timeline, and profitability of a construction project. Labor productivity is considered one of the best indicators for efficiency during construction projects. Focusing on the effects of weather conditions on labor productivity, studies suggest that work performance decreases significantly at temperatures above 80 degrees Fahrenheit and below 40 degrees Fahrenheit. Furthermore, relative humidity below 80% has been observed to greatly impact work efficiency. As temperatures rise above 80 degrees, relative humidity becomes an important factor in work efficiency.

Accordingly, there remains a need in the art for tools that account for weather factors in the long term planning and bidding of construction projects and other weather-sensitive economic activities.

### SUMMARY OF THE INVENTION

Provided herein are novel tools that account for weather factors in the long term planning and bidding of construction projects and other weather-sensitive economic activities. The tools of the invention utilize historic weather data and probabilistic analyses to provide accurate predictions of time losses likely to occur due to weather-related work stoppages and reductions in productivity.

The tools of the invention provide accurate forecasting of lost time due to weather conditions and allow for improved scheduling and competitive bidding. In one aspect, the tools of the invention aid contractors in planning for overtime requirements and potential economic losses. The tools of the invention further provide precise labor productivity assessments that can assist in reliable scheduling, which in turn can result in greater profitability. In another aspect, the tools of the invention provide a comprehensive estimate of weather impacts utilizing multiple factors that facilitate the preparation of realistic schedules, cost estimates, and reliable bids.

In a first aspect, the tools of the invention encompass novel processes for predicting weather effects on projects. The processes of the invention include computer-implemented methods of predicting weather effects on productivity. In another aspect, the tools of the invention encompass novel systems comprising various hardware and software elements utilized in combination to perform the novel methods of the invention. In another aspect, the scope of the invention encompasses novel devices which can perform the operations of the invention to provide valuable predictions for planners.

### BRIEF DESCRIPTION OF THE DRAWINGS

FIG. 1 is a flow chart for performing an exemplary method of the invention, depicting the various steps of the method to generate a prediction of project completion time based on weather factors.

FIG. 2 depicts an example of the general process of calculating weather effects on productivity for a given time interval.

FIG. 3 depicts an exemplary system of the invention, including the various elements that work together to perform the processes of the invention.

FIG. 4 depicts an exemplary output of the predictive process of the invention for a specific task, comprising estimates of the probability of completing the task within various timeframes.

FIG. 5 depicts the time to complete a specific task predicted by the methods of the invention for different times of the year.

FIG. 6 depicts an exemplary output of the predictive process of the invention for a specific task, comprising estimates of the probability of completing the task within various timeframes.

FIG. 7 depicts an exemplary output of the predictive process of the invention for a specific task, comprising estimates of the probability of completing the task within various timeframes based on labor productivity effects.

### DETAILED DESCRIPTION OF THE INVENTION

The various inventions disclosed herein are directed to the prediction of weather effects on the performance of projects such as construction projects. The various inventions described herein utilize historic weather data to accurately predict the effects of weather on productivity, and the probability of completing specified tasks within various time periods.

In a general implementation, the invention encompasses a first method of calculating, at a given probability threshold, the probability that work will be stopped during a particular time unit based on (1) historical weather data for the project site for that time and (2) threshold weather values that cause work stoppage. For example, the time unit may comprise an hour of the day on a specific date, for example, 9 AM on November 1. Likewise, the time unit may comprise a daily value, for example, November 1. The project site can be any site for which historical weather data is available or can be interpolated or estimated. For example, the site may be Los Angeles, Calif. or other locality. The threshold weather values that cause work stoppage are weather values above or below which the particular tasks of the project cannot be performed, for example due to worker safety or comfort, materials or equipment issues, or regulatory requirements. For example, if the particular project is a construction project utilizing cranes, work may be stopped during time units wherein a maximum wind speed of 40 MPH is exceeded because of the danger of accidents. In another example, if the project is a construction project wherein concrete is being poured, work may be stopped during time units wherein the minimum temperature is below 20° F. because the concrete will not set properly at such temperatures.

The work stoppage predictions are made in a probabilistic manner, wherein the probability of meeting the work stoppage threshold value, for example 40 MPH maximum windspeed or a temperature of below 20° F. or below, is calculated for each time unit using the historical weather data for that time and location.

The method of the invention comprises a second step, wherein productivity is predicted during a selected time unit, wherein the effects of weather on productivity are calculated. For many tasks, productivity is sensitive to one or more weather factors. For example, workers may be less productive at high temperatures and high humidity due to the discomfort of such conditions. Likewise, machinery may be less efficient when there is significant precipitation. In one step of the methods of the invention, these weather effects on productivity are quantified.

In the method of the invention, the two predictive steps described above, work stoppage and productivity predictions, are combined and integrated them over the course of a project date range, providing a weather-based prediction of production over time. The methods provided herein are immensely useful for planning as they provide a realistic forecast of production based on weather.

Each element of the method of the invention is described in detail next.

Project Parameters.

A primary element of the method includes the project variables. A first project variable is the project type. As used herein, a “project” is an undertaking or endeavor, wherein the undertaking or endeavor has an element of weather risk—i.e. the time required to complete the project or a task within the project is in part dependent upon weather variables. In one embodiment, the project is a construction project, including, for example, road building, construction of a structure, including denovo fabrications, renovations, and combinations thereof. For convenience, the description provided herein will be directed to construction projects, however it will be understood that the method may be applied to other endeavors having a weather risk element. For example, the the project may comprise a transportation project, aviation project, retail supply-demand management project, labor productivity assessment project, weather-related human health impact assessment project (for example, evaluating exposure to heatwaves, extreme wind, extreme precipitation), or agricultural endeavor.

The project will be defined by a relevant unit of production or output. In one embodiment, for example, in the case of a construction project, the relevant measure of production may be work performed, for example, the unit can be an “effective person-hour.” An effective person-hour is an hour for which work accomplished by a single worker without negative weather effects. It will be understood that other units of production or output may be utilized as relevant to the particular project. If the project is a transportation project the relevant unit might be miles travelled. Other units of production might include units produced, hours of machinery operated, etc.

The project will be defined by a production or output requirement, the production requirement being the amount of work or production necessary to complete the task. For example, a particular construction project might be defined as requiring 1,000 person hours of labor to be completed.

Another project variable is the putative date range of the project. Here, a starting date is selected and a number of days thereafter will span the putative date range. Generally, for the purposes of the invention, a date range may encompass the estimated amount of time necessary to complete the project under optimal conditions, plus a cushion of time representing potential weather delays. For example, the date range can be defined as 110%, 125%, 150%, or 200% of the time required to perform the project under optimal conditions. For example, a 125-day date range may be specified for a 100-day project.

The putative date range will be broken into individual time units, each time unit representing a time interval during which work can potentially occur. The methods of the invention may be applied at any time scale, for example, hourly, daily, weekly, or monthly. Generally, hourly or daily production is utilized, but finer or larger time intervals may be used, as selected by the user. The putative date range of the project is treated as a sequential series of time units representing times that work can occur, for example taking working hours, weekends, and holidays into account. For example, for operations occurring during normal business hours of a typical forty hour work week, a selected week will be broken into a series of forty individual hours, from 9 AM to 5 PM on Monday through Friday. For more complex projects, the variables and constraints that will define the available hours for performance of the project can be taken into account, for example, the number of working hours per shift, the number of shifts per day, the timing of shifts, etc.

Another project variable is capacity, being the number of production units that can potentially be performed per unit time. For example, the number of workers can be used as a measure of capacity, for example, in the context of a construction project.

Weather Effect on Production.

The function of the invention is to apply weather predictions to tasks to forecast weather effects on production. Each project type is associated with its own weather risks. For example, for a given project, it may be deemed that workers cannot work when the ambient temperature exceeds a safe or comfortable maximum (e.g. 100 degrees F.), or it may be that certain equipment (e.g. cranes) cannot be operated when wind speed exceeds a safe operating limit. Accordingly, in one step of the invention, an association is made between the project type and the relevant weather variables. Such association can be made manually, for example, with the user selecting the relevant weather variables. In the automated methods of the invention, these values can be retrieved in an automated fashion by a computing device upon user's specification of a specific project type. For example, the relevant weather variables associated with a particular project type can be be stored in a database comprising a memory device and can be retrieved upon user's specification of a particular project type.

In the methods of the invention, weather is assumed to affect production in two ways. In a first way, weather may cause a work stoppage. Work stoppage is defined as a time interval during which production is zero due to a weather effect. Such variables will be referred to herein as work stoppage weather variables, being a weather factor that can stop work in a particular project type. Work stoppage occurs when a threshold value for the work stoppage weather variable is met. For example, the work stoppage variable may comprise temperature, wherein, for a particular project type, work will stop if the temperature drops to or below a specific value. For example, in a hypothetical case, workers may not be able to work if the temperature drops below 20° F. Accordingly, for a specific time unit (for example, 9 AM on November 1), the work stoppage weather variable is air temperature and the work stoppage threshold value is 20° F. The threshold is said to be met if the temperature is 20° F. or below. Likewise, if work cannot proceed above a weather variable value, the threshold is “met” if that threshold value is reached or exceeded. For example, if the project is painting and the paint cannot be properly applied at relative humidities above 90%, the threshold is met if relative humidity is 90% or above. Accordingly, as used herein “meeting” the threshold value means reaching or exceeding a maximum threshold value or reaching and passing below a minimum threshold value.

Work stoppage threshold values can be specified by the user based on experience, published values, or regulatory requirements. In the automated methods of the invention, these values can be input manually by the user or can be retrieved in an automated fashion by a computing device upon user's specification of a specific project type. For example, the work stoppage threshold values can be stored in a database comprising a memory device.

A second weather risk is the risk of reduced productivity due to weather. Workers, materials, and/or equipment performance can be negatively affected by extremes of temperature, wind chill, heat plus humidity, precipitation, and wind. Such weather variables will be referred to herein as “productivity weather variables,” a productivity weather variable comprising a weather variable wherein the productivity of a certain project type is sensitive to the value of the variable. The relationship between a productivity weather variables and productivity is expressed as a mathematical relationship between the weather variable value and the measure of productivity. For example, in one embodiment, the measure of productivity is an effective person-hour and the weather-productivity is expressed as effective person-hours per hour as a function of the weather variable. For example, in one embodiment, a worker's average productivity in optimal weather is one person-hour of production per hour (100% productivity) and productivity of the worker will range by a factor between 0 and 100% depending on the value of one or more selected productivity weather values. For example, as depicted in Table 1, worker productivity is sensitive to temperature and humidity, with significant reductions in productivity as temperature and humidity increases.

Productivity-weather relationships (equations) can be input manually by the user, for example, based on experience or published values. In the automated methods of the invention, these equations can be can be retrieved from a memory. For example, productivity-weather relationship equations can be stored in a database comprising a memory device and relationships relevant to a particular project type can be retrieved in an automated fashion by a computing device upon user's specification of the project type.

Because different activities have different weather risks, complex projects may be divided into sub-parts, each having different risks pertinent to the work being performed in that phase of the project. For example, in constructing a large building, compared to putting in windows, pouring a concrete foundation may be more sensitive to low temperature and less sensitive to wind speed. Weather related delay forecasts can be separately generated for these phases of the construction to reflect the diverging effects of weather on different types of activity.

Weather Data.

The method of the invention quantifies the impact of weather risks on production using historical weather data. In one step of the invention, the relevant weather data is retrieved from a database. Weather data will comprise “weather variables,” which encompass any number of climatological factors, for example, precipitation, temperature, humidity, wind speed, wind chill, and other factors known in the art which describe weather. If weather data of a particular type is not available, in some cases it can be calculated from primary data. For example, wind chill can be calculated from temperature and wind speed data. As described above, the identity of the relevant weather variables is determined by the project type, wherein relevant weather variables are those having an impact on performance of the project type.

The weather data retrieved will be weather data relevant to the project site. Generally, weather data from the locality wherein the project is taking place will be available. If such data is not available, consensus weather data values may be calculated using data from one or more nearby locations, by methods known in the art.

The retrieved weather data will encompass a date range, the date range matched to the putative date range of the project. For example, if the project is projected to start May 1 and proceed for as long as 100 days, historic weather data for May 1-August 9 will be retrieved.

The retrieved weather data can be matched to the time scale of the analysis. For example, if the analysis is performed at an hourly time scale, hourly weather data can be retrieved. If weather data for the relevant time scale is not available, available weather data may be retrieved and used to estimate the required data. For example, if hourly temperature data is required and the only available data is daily minimum and maximum temperature, hourly temperatures can be estimated therefrom using methods known in the art.

In general, it is preferred that several years' worth of weather data be included, for example, at least twenty years of data, at least thirty years of data, or at least thirty-five years of data may be retrieved.

In one embodiment, weather data for the project location is input to the model. In another embodiment, forecasted weather data is retrieved in an automated fashion by a computing device from a file or from one or more weather databases having weather data relevant to the location of the project.

Method of the Invention.

With the various elements of the method described above, the performance of the method will be described next. In a general method, the invention comprises a method of combining work stoppage and productivity probability distributions, based on probabilistic distributions of values for relevant weather variables, to arrive at a new probabilistic distribution of productivity for each time unit. The productivity values in the distribution can be multiplied by capacity (determining how much work will be performed for each time unit) and summed, proceeding from the start date of the project over the defined series of time points, to create an integrated probabilistic distribution of the project's completion date.

In one exemplary embodiment, wherein work performed (for example, in effective persion hours) is the unit of production, the general method of the invention comprises a method of predicting the time required to perform a project, comprising the followings steps.
specifying the project type, project productive requirement, capacity, project location, putative project performance date range;
based on the specified project type and by means of a database relating weather variables to project type, selecting one or more weather variables wherein the one or more weather variables comprises a work stoppage weather variable and/or comprises a productivity weather variable;
retrieving weather data comprising historical values for the one or more selected weather variables, wherein the weather data is associated with the project location, for a series of time units over the putative project performance date range;
for each unit of time and for each selected weather variable, performing a probabilistic analysis that creates a distribution of weather variable values and associated probabilities for each such value;
for each unit of time, for each variable comprising a work stoppage weather variable, applying the work stoppage threshold to the predicted distribution of weather variable values, wherein an effective productivity of zero is assigned to all values that meet the threshold and a productivity factor of one is assigned to all values that do not meet the threshold;
for each unit of time, for each predicted weather variable that comprises a productivity weather, applying a weather-productivity relationship to the predicted values and calculating the effective productivity factor for each weather variable value;
combining the distributions for each weather variable for each time unit to create a probabilistic distribution of the effective work factor for each time unit, multiplying by capacity, and summing the probabilistic performance distributions of each time unit to create a probabilistic distribution of project completion dates at which the project productive requirement value will be met;
outputting the results for the user.

A first step of the process is the specification of project parameters, including the the project type, project productive requirement, capacity, project location, putative project performance date range, and selected probability threshold. In this step, the various parameters of a specific project are input or selected by a user or users. For example, a user utilizing a device such as a desktop computer, laptop computer, mobile device, other device comprising a means of inputting data. For example, the input may comprise a graphical user interface and hardware (e.g. keyboard, mouse, display, etc.) to enable input or selection of the project variables. Subsequent steps of the method can be performed by a computer device.

Work Stoppage Calculation.

Work stoppage is predicted with a probabilistic model. The method relies on calculating the probabilities of meeting work stoppage thresholds for any applicable work stoppage weather variable during each time unit of the putative date range. For example, if a particular activity cannot be performed at temperatures below 50° F. and also cannot be performed if precipitation is greater than 2 mm, the work stoppage variables for such activity would be temperature and precipitation and the work stoppage thresholds for temperature and precipitation would be 50° F. and 2 mm, respectively. Accordingly, the method of the invention would encompass predicting the probability distribution of values for each of the weather variables, for each time unit, wherein the probability that the temperature will be 50° F. or less and the probability that precipitation will be 2 mm or greater can be determined. A productivity factor of zero is applied to those temperature and precipitation values in the distributions that meet (are less than 50° F. or which exceed 2 mm precipitation).

Any number of probabilistic techniques known in the art may be used to predict weather variable values for a given time unit. In one embodiment, the probabilistic approach utilized is the cumulative distribution function. This function predicts the probability of a variable meeting a threshold value based on known variability around the variable. For example, the probability of a certain air temperature being reached on a certain date can be predicted from historical weather data using the cumulative distribution function, for example, the empirical cumulative distribution function or parametric cumulative distribution function. Other probability functions may be used, including an empirical probability density function, or a parametric probability density function, as known in the art.

Alternatively, other probability plotting functions known in the art, such as the Adamowski, Beard, Blom, Chegodayev, Cunnane, Hazen, Hirsch, IEC56, Landwehr, Laplace, Mc Clung, Tukey, Filliben estimator, Weibull, Gumbel and Anon methodologies may be employed.

Weather Effects on Productivity.

If it is predicted that work will proceed during a selected time unit, the calculated effective productivity factor during the selected time unit will determine production. In this step, the probabilistic distribution of productivity weather variable values relevant to the project are calculated for a given time unit. As above, such predictions may also be made by probabilistic models, such as the cumulative distribution function, or by other forecasting tools known in the art. Once the predicted distribution of weather variable values has been calculated for a productivity weather variable, the mathematical formula relating the weather variable to productivity is applied. For example, the factor can range from 0 to 1.

Prediction and Output.

Using the work stoppage and labor productivity calculations described above, an integrated forecast of the progression of the project is calculated by combining the probabilistic productivity factor distributions. For example, the probabilistic distribution of productivity factors at each time unit across the time series may be calculated, and these values in the distribution may be multiplied by the capacity to determine the probabilistic distribution of work performed during each time point. These probabilistic distributions of work performed may be summed for each time unit in the series, commencing on the start date of the project, to create a probabilistic distribution of end dates, i.e. dates and associated probabilities thereof, on which the total production requirement of the project is reached.

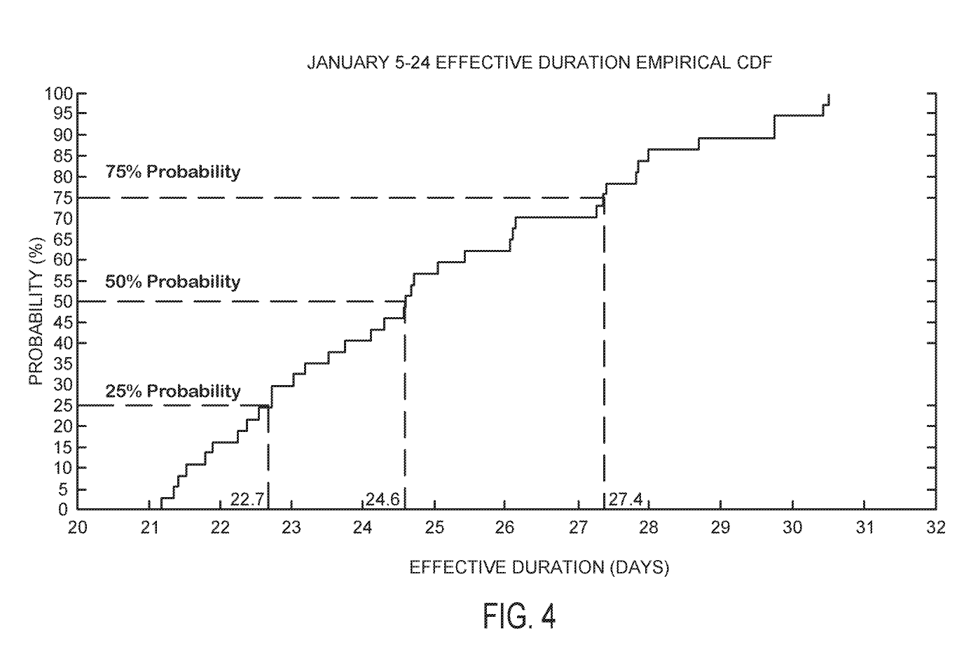

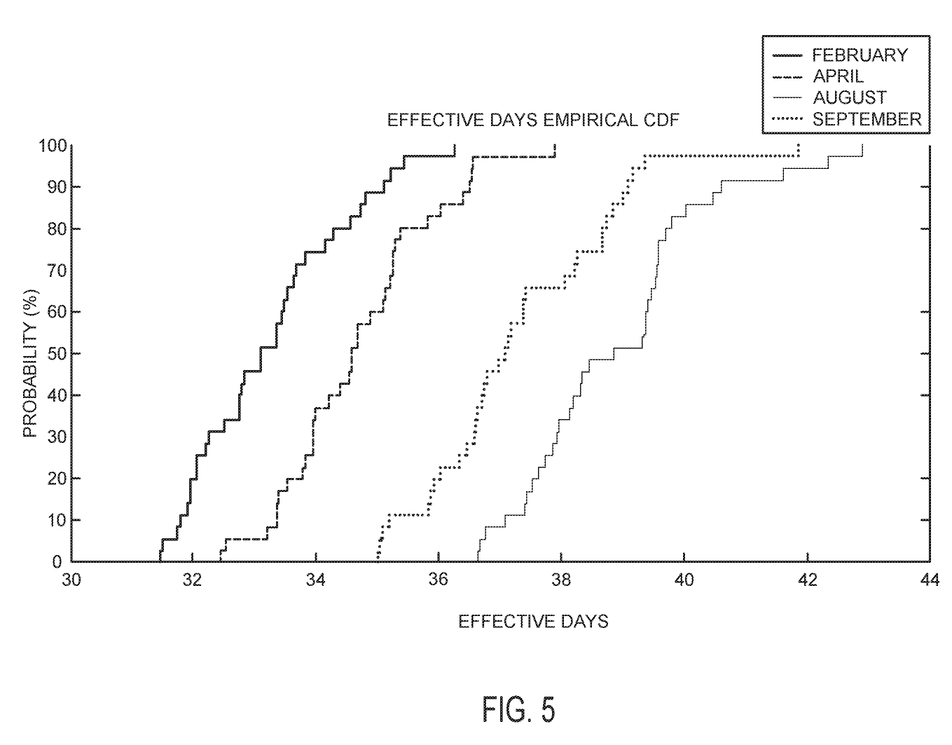

In a final step, the forecasts are output for the user. The output may comprise a probabilistic distribution of end dates. The output may comprise a cumulative distribution function, which tells, for a selected x axis value (time to completion), the probability that the value outcome will be less than the selected value. For example, end date probabilistic distributions (comprising a cumulative distribution function) are depicted in FIGS. 4, 6, and 7. Multiple probabilistic distributions can be attained for different start dates, for example as depicted in FIG. 5. In alternative embodiments, the output is a probability density function.

In other embodiments, the output is a value derived from the above calculations. For example, survival functions, percentile point functions, or inverse survival functions may be calculated from the probabilistic calculations of the invention to provide different forms of output. The output may comprise a projected project completion date within a specified probability window, for example, “a seventy five percent chance that the project will be completed in 100 days or less.” The output of the method comprises a distribution of predicted weather-related delays (e.g. days or hours lost). In one embodiment, the output is a probabilistic distribution of project expense, for example, calculated on the basis of predicted time required to complete the project and costs such as labor rates and equipment operation costs. In other embodiments, the output may comprise a numeric value, a probability, a confidence interval, or a combination of the foregoing.

The output may be in the format of displayed graphics, a printout, or a file summarizing the results, or as data.

### Exemplary Embodiments of the Invention

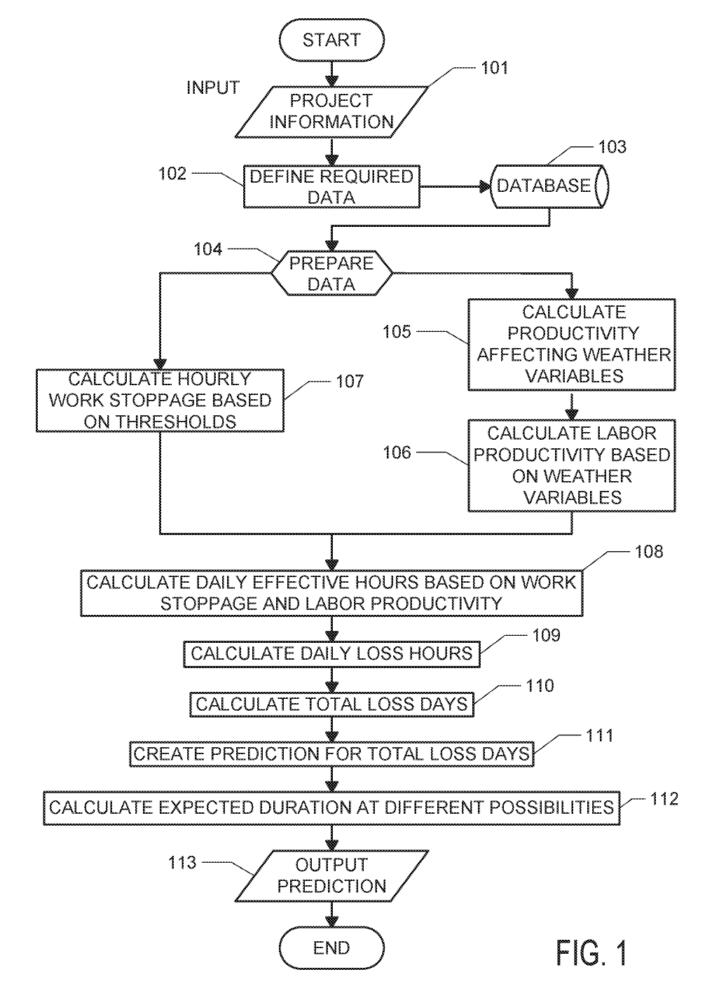

FIG. 1 depicts an exemplary implementation of the method of the invention in a software flow chart. The process commences with specification of project parameters (101). In a second step of the process of the invention (102) the required data is defined based on the project parameter inputs. The required data is retrieved (104) from one or more memory locations such as databases (103), including work stoppage threshold values, work-productivity relationships, and weather data. Alternatively, the data can be requested from the user(s), who can subsequently supply (input or upload) the requested data. After the required data has been supplied, it can be analyzed to determine the probability of work stoppage (107) and productivity losses to weather (108). Total daily lost hours are calculated (108) and summed to determine total lost days (109). These calculation steps (107-110) can be repeated at different probability thresholds to create a prediction of total lost days at different probability thresholds (111). In a final step, the duration of the project a different probability thresholds is calculated (112) and is output for the user (113).

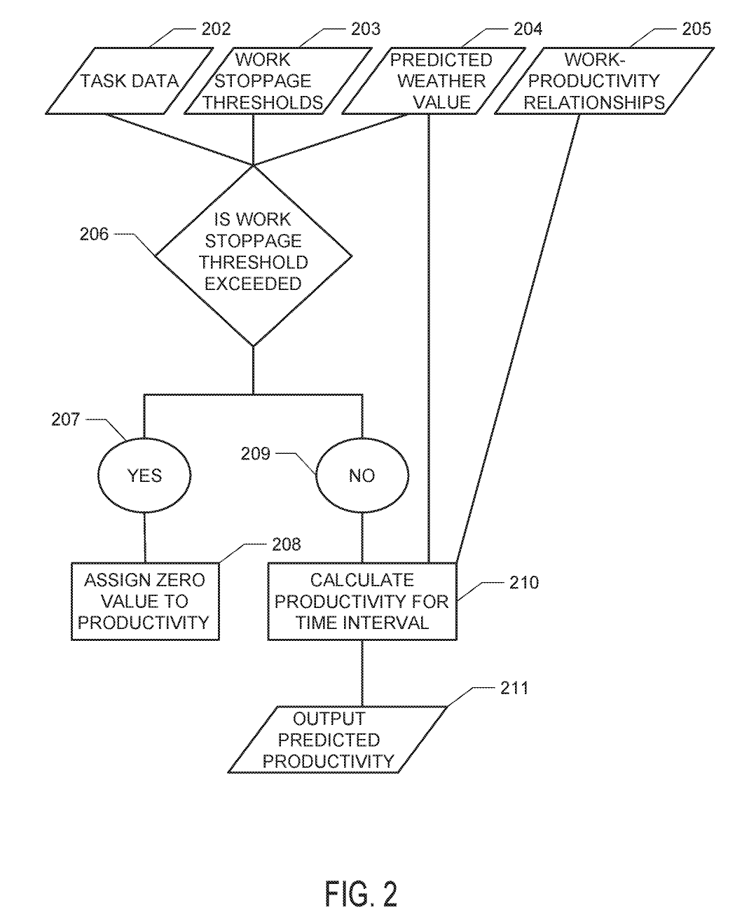

Work stoppage and productivity losses can be calculated, for each weather variable and for each time unit of the time series, as in FIG. 2. Based on the project data (202), the relevant work stoppage threshold value for a selected weather variable has been retrieved or input (203). Weather data (204) and a selected probability threshold are utilized to determine if the weather variable value will meet the work stoppage threshold value. If the threshold is met (207), the hourly value of work performed is assigned a zero value (208) and this is output as the predicted effective productivity for the time unit. If the threshold is not exceeded (209), the stored mathematical relationship between productivity and the weather variable value (205) is applied to the predicted value of the weather variable (204) and the effective productivity is calculated (210).

### Advantages of the Invention

In some embodiments, the invention comprises entirely novel solution spaces for addressing the problem to which it is directed. In other embodiments, the inventions comprise improvements to the prior art, the improvement being the substitution or addition of one or more novel elements or processes which enhance the prior art solutions.

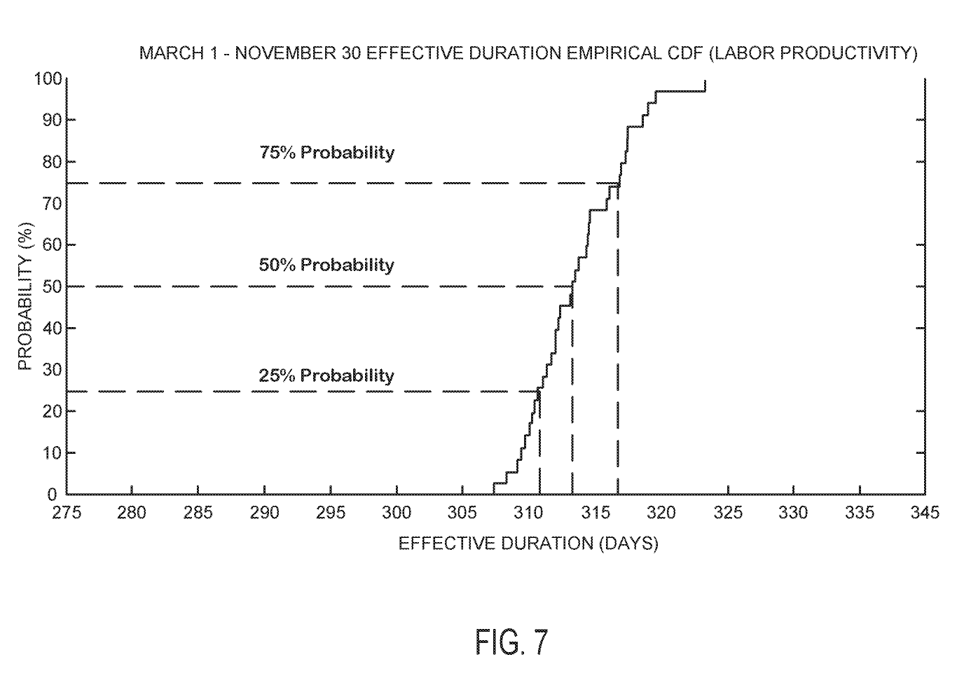

Other methods of forecasting weather effects on productivity are known. The methods of the invention provide various significant advantages over the prior art. The methods of the invention encompass a probabilistic method of determining weather effects on production using historical weather data, for example 35 year weather data sets. This provides the user with an accurate forecast that takes into account the variability of weather at the project site, and provides a probabilistic analysis in a convenient output format, such as in FIG. 5, that efficiently conveys the weather risks at different probabilities. The methods of the invention allow users to determine mean performance times (most likely performance times) or mode values of performance time (highest probability density). The use of the cumulative distribution function is especially useful in providing a graphical representation of weather risks. The simulations can be run with different weather variables. The simulations can be run with different work stoppage weather variable thresholds or weather-productivity relationships, or can be run with only work stoppage effects or productivity effects (as in FIG. 7) taken into account to illustrate the different components of weather delays. The probability distributions of the invention may be expressed as different types of

### Implementations of the Invention

The methods of the invention may be implemented in various ways. In a first aspect, the scope of the invention encompasses a computer implemented method of performing the processes described herein. In such embodiments, the methods of the invention are executed on a computing device, wherein project variables have been input or selected by a user and are retrievable from a memory device; wherein work stoppage thresholds and weather-productivity relationships are likewise stored and retrievable from a memory device; wherein weather data is also stored and retrievable from a memory device or network (such as the internet), and wherein the subsequent steps of the process are executed by computer device. The computer device may comprise a general purpose computer comprising a processor. The invention may be carried out in a networked environment, with various embodiments of the invention, including the input of variables and output of results being carried out on two or more different processors, servers, or devices, the two or more elements being connected by a network, such as the internet. It will be understood by one of skill in the art that the invention is practiced in any computing environment, broadly encompassing any type of computer, computer network, or combinations thereof and that practice of the invention is not limited to any single configuration of computers, operating systems, or programming languages.

In one embodiment, the invention comprises a computer program product which carries out the operations of the methods disclosed herein. In another embodiment, the invention comprises non-transitory computer-readable storage medium having computer-readable program instructions stored therein, wherein the machine readable instructions which carry out a series of operations that perform the methods disclosed herein. In another embodiment, the invention comprises a memory device on which are stored machine readable instructions that perform the processes of the invention. In yet another embodiment, the invention comprises a device which has the aforementioned memory device within it or is otherwise in connection therewith.

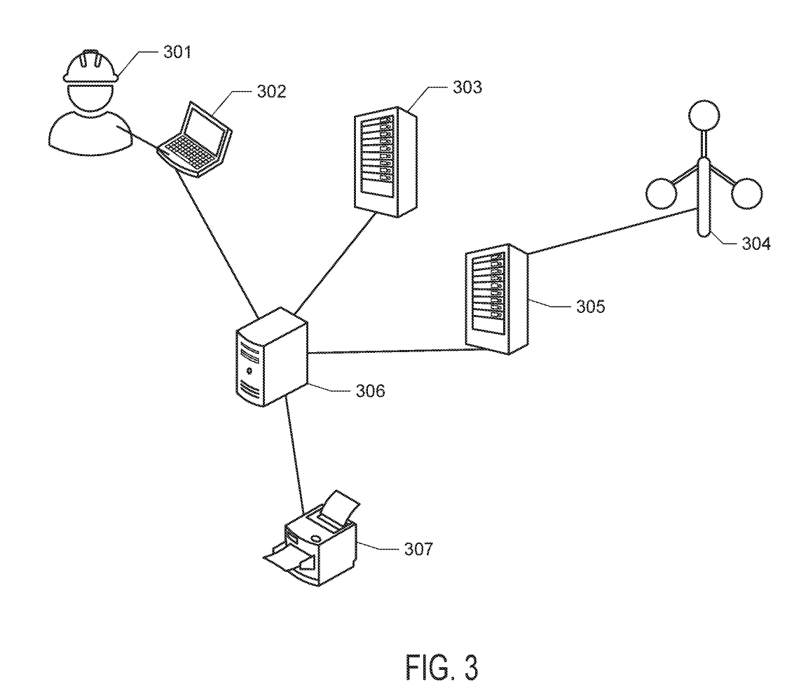

In one aspect, the inventions described herein comprise systems, wherein specific processes are carried out using a combination of hardware elements and machine readable instructions that perform the processes of the invention. An exemplary system of the invention is depicted in FIG. 3, wherein a user (301), by means of a device (302) inputs the project variables. Productivity and weather relationships may be stored on a memory or server (303). Weather data may be stored on a memory device or server (305), for example in connection with weather sensors (304). The method of the invention may be performed on a computer device or processor (306), and the output of the method can be displayed, printed, or otherwise made available to the user on an output device (307).

### EXAMPLES

### Example 1. Weather Augmented Risk Determination System

A software product named Weather Augmented Risk Determination System (WARDS) was developed. The weather data sets this software uses data from the North American Land Data Assimilation Systems (NLDAS) which has been used in a wide variety of studies. In the current version of the model, the climate variables used include: Precipitation, temperature, specific humidity, relative humidity, pressure, wind, solar radiation, Soil moisture. Precipitation, temperature, specific humidity, pressure, wind and solar radiation are from the observation-based forcings. Soil moisture is from Noah LSM Model and relative humidity is calculated using specific humidity and pressure using as:

$$RH = 0.263 {pq [ exp ( \frac{17.67 ( T - {T}_{0} )}{T - 29.65} ) ]}^{- 1} . \qquad Equation 1$$

where q is specific humidity or the mass mixing ratio of water vapor to total air (dimensionless) p is pressure (Pa), T is temperature (K), TO is reference temperature (typically 273.16 K) (K) These data sets have 0.125° spatial and hourly temporal resolutions. The data record covers 1980-present. The data can be access from: http://disc.sci.gsfc.nasa.gov.

The user inputs the project information such as project location, project and task dates, and project constraints. Project constraints include thresholds to which each task is sensitive. Example constraints include: working days, working hours per shift, number of shifts during each day, and holidays.

Additional constraints can be added depending on the type of the project and safety compliance issues. Using the selected constraints, the program extracts the necessary data from the database. The program then calculates the probabilities of work stoppage for each hour using historical weather data and creates a cumulative distribution function (i.e., identifies the risk of work stoppage based on climatology in the location of interest). The probability of stoppage is estimated by counting the number of times the variable goes above or below a user defined threshold (e.g., hourly temperatures exceeding 110° F.). This analysis is based on the cumulative distribution function (CDF) of the variable of interest:

F(x)=P(X≤x) Equation 2.

which gives probabilities of passing the task threshold for each working hour throughout the project using the historical weather data. (x) is the probability of random value X being less than or equal a specified value x. The program analyzes work stoppage based on all the variables that can potentially affect the project. For example, assuming, temperature (X), precipitation (Y) and relative humidity (Z) as the critical variables:

F1(x)=P(X≤x)

F2(y)=P(Y≤y)

F3(z)=P(Z≤z) Equations 2-5:

Each distribution shows the statistics of the relevant variables for the user defined thresholds (e.g., temperatures exceeding a certain threshold). The program also determines the hourly labor productivity percentage based on Table 1 and Table 2, using historical temperature, wind speed, and relative humidity data.

Table 1: Journeymen Productivity Percentage at Various Environmental Conditions (Source: Hanna, Awad S. The Effect of Temperature on Productivity. Bethesda, Md.: NECA, National Electrical Contractors Association, 2004)

| Wind Speed | Actual Temperature(° F.) | | | | | | | | | | | | | | | | | |
|---|---|---|---|---|---|---|---|---|---|---|---|---|---|---|---|---|---|---|
| (MPH) | 40 | 35 | 30 | 25 | 20 | 15 | 10 | 5 | 0 | −5 | −10 | −15 | −20 | −25 | −30 | −35 | −40 | −45 |
| Calm | 40 | 35 | 30 | 25 | 20 | 15 | 10 | 5 | 0 | −5 | −10 | −15 | −20 | −25 | −30 | −35 | −40 | −45 |
| 5 | 34 | 31 | 25 | 19 | 13 | 7 | 1 | −5 | −11 | −16 | −22 | −28 | −34 | −40 | −46 | −52 | −57 | −63 |
| 10 | 32 | 27 | 21 | 15 | 9 | 3 | −4 | −10 | −16 | −22 | −28 | −35 | −41 | −47 | −53 | −59 | −66 | −72 |
| 15 | 32 | 25 | 19 | 13 | 6 | 0 | −7 | −13 | −19 | −26 | −32 | −39 | −45 | −51 | −58 | −64 | −71 | −77 |
| 20 | 30 | 24 | 17 | 11 | 4 | −2 | −9 | −15 | −22 | −29 | −35 | −42 | −49 | −55 | −61 | −68 | −74 | −81 |
| 25 | 29 | 23 | 16 | 9 | 3 | −4 | −11 | −17 | −24 | −31 | −37 | −44 | −51 | −58 | −64 | −71 | −78 | −84 |
| 30 | 28 | 22 | 15 | 8 | 1 | −5 | −12 | −19 | −26 | −33 | −39 | −46 | −53 | −60 | −67 | −73 | −80 | −87 |
| 35 | 28 | 21 | 14 | 7 | 0 | −7 | −14 | −21 | −27 | −34 | −41 | −48 | −55 | −62 | −69 | −76 | −82 | −89 |
| 40 | 27 | 20 | 13 | 6 | −1 | −8 | −15 | −22 | −29 | −36 | −43 | −50 | −57 | −64 | −71 | −78 | −84 | −91 |
| 45 | 26 | 19 | 12 | 5 | −2 | −9 | −16 | −23 | −30 | −37 | −44 | −51 | −59 | −65 | −72 | −79 | −86 | −93 |
| 50 | 26 | 19 | 12 | 4 | −3 | −10 | −17 | −24 | −31 | −38 | −45 | −52 | −59 | −67 | −74 | −81 | −88 | −95 |
| 55 | 25 | 18 | 11 | 4 | −3 | −11 | −18 | −25 | −32 | −39 | −46 | −54 | −62 | −68 | −75 | −82 | −89 | −97 |
| 60 | 24 | 17 | 10 | 3 | −4 | −11 | −19 | −26 | −33 | −40 | −48 | −55 | −62 | −69 | −76 | −84 | −91 | −98 |

Source: National Weather Service

The program then creates a CDF for labor productivity for each hour of the project using historical weather data. Having both labor productivity and weather information, for each hour, the program calculates the daily effective hours (hours the project will actually take due to delays from weather conditions) based on both work stoppage and labor productivity using: Equation 6.

$${DEH}_{j} = {\sum }_{i = 1}^{wh} {EHP}_{i , j} * {EHTMX}_{i , j} * {EHTMN}_{i , j} * {EHRH}_{i , j} * {EHW}_{i , j} * {EHSR}_{i , j} * {EHSM}_{i , j} * {LP}_{i , j}$$

where: i: hour, j: day, wh: working hours per day, DEH: daily effective hours, EHP: effective hours due to precipitation, EHTMX: effective hours due to maximum temperature, EHTMN: effective hours due to minimum temperature, EHRH: effective hours due to relative humidity, EHW: effective hours due to wind, EHSR: effective hours due to solar radiation, EHSM: effective hours due to soil moisture, and LP: is labor productivity.

The DEH (daily effective hours) equation should only include variables that can potentially affect the project. For example, if only precipitation, maximum temperature, relative humidity and labor productivity are relevant to the project, the final equation will reduce to:

$${DEH}_{j} = {\sum }_{i = 1}^{wh} {EHP}_{i , j} * {EHTMX}_{i , j} * {EHRH}_{i , j} * {LP}_{i , j} . \qquad Equation 7$$

where EHP, EHTMX, EHTMN, EHRH, EHW, EHSR, and EHSM are binary values, representing whether or not work will stop in a specific hour due to each variable and their thresholds at different probabilities. Put differently, for each hour, WARD System extracts the data from the past 35 years and evaluates whether work stoppage would happen (weather variables exceed the user specified thresholds). If one of the individual variable values equals zero during a specific hour in a certain year, then the entire hour will equal zero because at least one weather variable has passed the threshold (e.g., work stoppage due to extreme precipitation even though temperature condition is ideal). The program creates a CDF for each hour of the project period using the historical data. Unlike weather terms in the DEH equation, LP (labor productivity) can be any number between 0 (no productivity) and 1 (perfect productivity). Higher LP values represent higher work efficiency, and lower LP values represent lower work efficiency. If no threshold is passed during a certain hour, labor productivity due to temperature, wind, and relative humidity is the only weather factor that can delay a task for that hour.

After calculating the daily effective hours, the program computes the CDF for daily lost hours using

DLHⱼ=wh−DEHⱼ Equation 8.

Next, the WARD System calculates the total lost days CDF as:

$$TLD = {\sum }_{j = 1}^{n} \frac{{DLH}_{j}}{wh} . \qquad Equation 9$$

where TLD is the total lost days and n is the expected task duration without accounting for weather conditions and labor productivity. The expected duration of the project can then be estimated as the initial estimates (without the weather effect) plus the total lost days because of weather-related work stoppage and labor productivity. FIG. 1 provides an overview of the flowchart.

To provide an example for how the software works, application to a single short task (hereafter, Task 1) is demonstrated in a construction project in Washington D.C. Task 1 construction is planned for January 5 to January 24 (excluding the potential weather-related impacts). It is assumed there is an eight hour workday, and work continues seven days a week.

Assuming Task 1 is sensitive to: precipitation above 2 mm/day, maximum temperature above 100 degrees Fahrenheit, minimum temperature below 10 degrees Fahrenheit, and wind above 20 miles per hour. After providing the required information, WARD System offers a CDF with estimated duration at different probabilities. This estimated duration takes into account probabilities of weather stopping work, as well as the effects of wind, temperature, and relative humidity on work efficiency. FIG. 4 shows a sample output of WARD System for Task 1. FIG. 4 shows that although the Total Work Days without weather interruptions is 20 days (January 5-January 24), weather interruptions can cause the task to take 22-31 days. This means that the project can take 10% to 55% longer than it would have under perfect weather conditions. FIG. 5 shows that the project will take 23 days (3 extra days) or less with 25% probability, 25 days (5 extra days) or less with 50% probability, and 28 days (8 extra days) or less with 75% probability. In the worst case scenario, the 20 day task can take 31 days, which could have substantial financial costs.

Ward system can also give an estimate of the best time to begin a task using historical weather data, the inputted thresholds, and location. For example, if example Task 2 is located in a cold region and sensitive to cold weather, but insensitive to precipitation, the best time to start a task would be in the summer. The opposite would be true if the project is located in a hot, humid, windy location, and the project task was sensitive to high temperatures. FIG. 5 shows the CDFs of effective days in each month with respect to the thresholds above. FIG. 5 shows that a task scheduled for Washington D.C. will take different amounts of time based on the time of year which it is scheduled for.

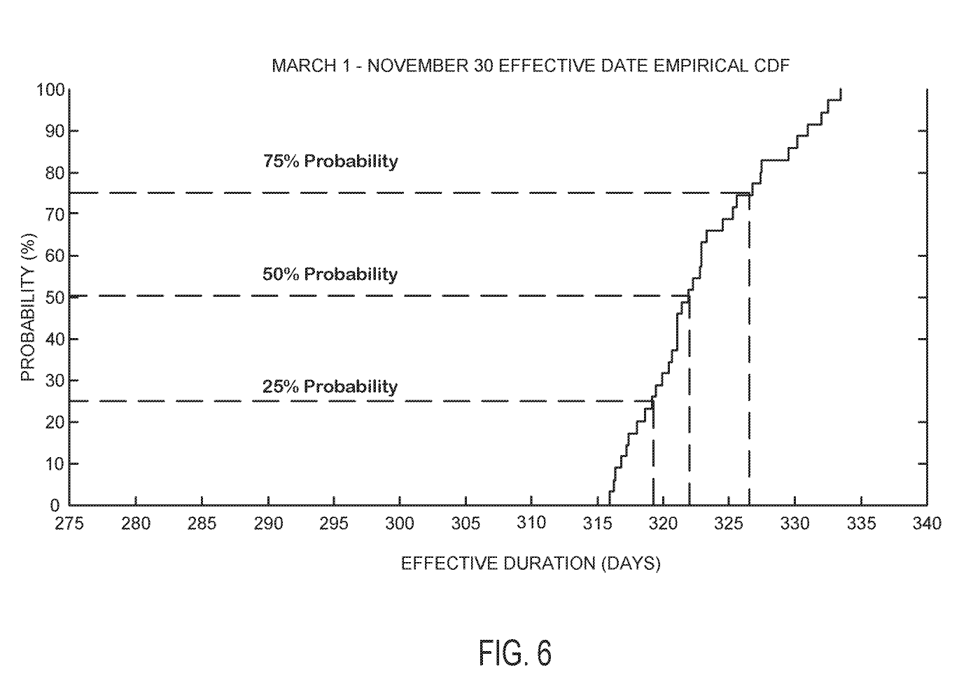

In another example, a longer task (Task 3) is analyzed, having a March 1 start and November 31 end dates without any weather delays. Again, it is assumed there is an eight hour workday, work continues seven days a week, and the same thresholds and location as Task 1. Without taking into account weather delays, the project will take 275 days. However, FIG. 6 shows the task will actually take between 316-334 days when considering weather delays. This means weather delays account for 15%-19% of the approximated task duration. FIG. 6 shows that the project will take 319 days (44 extra days) or less with 25% probability, 323 days (48 extra days) or less with 50% probability, and 327 days (52 extra days) or less with 75% probability.

To determine the effects of work stoppage versus delay due to labor productivity, FIG. 7 is created. This figure shows Task 4's CDF, which is in the same location as Task 3, and has the same working hours as Task 3. However, Task 4 has no thresholds for work stoppage, and is only affected by labor productivity. FIG. 7 shows that Task 4, which should only take 275 days actually takes anywhere between 308-323 days. This means that labor productivity alone adds 12%-17% delay to Task 4. Comparing Task 3 to Task 4 it can be deduced that labor productivity accounts for 79% of the total delay, with work stoppage only accounting for 21%.

### Example 2. Maps and Calendars

In One Implementation the Aforementioned Method can be used to generate predictive maps and calendars. In one embodiment, the aforementioned forecasting method is applied to predict a productivity measure over a selected date range at a plurality of sites. The productivity measure is any numeric value indicative of how much work likely will be done or how much work likely will be lost. For example, the productivity measure may be the probability of accomplishing a full workload (e.g. the anticipated productivity absent any weather related reductions in productivity), the probability of accomplishing a workload goal (e.g. 70% of normal workload), the probability of a reduction in productivity, or the anticipated number of hours lost due to weather factors. This productivity measure is calculated, over the date range selected by the user, at a plurality of sites having different weather data, e.g. adjoining sites within a selected region. The output of the method may be a map, for example, a color coded map, showing the anticipated productivity measure at the various sites on the map, allowing for a geographical overview of weather effects on a selected economic activity. Different iterations of the map may be generated for different probability thresholds, for example, thresholds input by the user. An exemplary output would be a map depicting those regions (e.g. denoted by color) wherein the probability that productivity will exceed a selected threshold (e.g. 70% of normal productivity) exceeds a selected threshold (e.g. 90%).

In another implementation, the methods of the invention are used to determine a productivity value for each date across a range of dates. The output of the prediction will be a calendar depicting the anticipated productivity measure for different time intervals, e.g. days, weeks, work weeks, or months.

All patents, patent applications, and publications cited in this specification are herein incorporated by reference to the same extent as if each independent patent application, or publication was specifically and individually indicated to be incorporated by reference. The disclosed embodiments are presented for purposes of illustration and not limitation. While the invention has been described with reference to the described embodiments thereof, it will be appreciated by those of skill in the art that modifications can be made to the structure and elements of the invention without departing from the spirit and scope of the invention as a whole.

What is claimed is:

1. A computer implemented method, implemented on a computing device, of calculating the time required to perform a project;
wherein the project type, project productive requirement, capacity, project location, and putative project performance date range have been specified by the user;
based on the specified project type and by means of a database relating weather variables to project type, selecting one or more applicable weather variables wherein the one or more weather variables comprises a work stoppage weather variable and/or comprises a productivity weather variable;
retrieving weather data comprising historical values for the one or more selected weather variables, wherein the weather data is associated with the project location for a series of time units over the putative project performance date range;
for each unit of time and for each selected weather variable, performing a probabilistic analysis that creates a distribution of weather variable values and associated probabilities for each such value;
for each unit of time, for each variable comprising a work stoppage weather variable, applying the work stoppage threshold to the predicted distribution of weather variable values, wherein an effective productivity of zero is assigned to all values that meet the threshold and a productivity factor of one is assigned to all values that do not meet the threshold;
for each unit of time, for each predicted weather variable that comprises a productivity weather, applying a weather-productivity relationship to the predicted values and calculating the effective productivity factor for each weather variable value;
combining the distributions for each weather variable for each time unit to create a probabilistic distribution of the effective productivity factor for each time unit, multiplying by capacity, and summing the probabilistic performance distributions of each time unit to create a probabilistic distribution of project completion dates at which the project productive requirement value will be met; and
outputting the results for the user.

2. The method of claim 1, wherein
the project comprises a project selected from the group consisting of a construction project, an agricultural project, a transportation project, an aviation project, and a retail supply-demand management project.

3. The method of claim 1, wherein
the project is defined in units of effective-person hours.

4. The method of claim 1, wherein
the one or more weather variables is selected from the group consisting of precipitation, temperature, humidity, wind speed, and wind chill.

5. The method of claim 1, wherein
the historical weather data comprises data compiled for at least thirty years.

6. The method of claim 1, wherein
the probabilistic analysis comprises an analysis selected from the group consisting of the empirical cumulative distribution function, empirical probability density function, parametric cumulative distribution function, and parametric probability density function.
